(19) United States
(12) Patent Application Publication
(10) Pub. No.: US 2002/0055832 A1
(43) Pub. Date: May 9, 2002

(54) Structured system for the planning, integration, analysis and management of new product development on a real-time, enterprise-wide basis

(76) Inventors: Anne T. Donelan, Roslindale, MA (US); Ralph G. Brown, Acton, MA (US); Richard S. Moore, Sudbury, MA (US)

Correspondence Address: Pandiscio & Pandiscio, 470 Totten Pond Road, Waltham, MA, 02451-1914, US

(21) Appl. No.: 09/888,355

(22) Filed: Jun. 22, 2001

Related U.S. Application Data
(60) Provisional application No. 60/213,463, filed on Jun. 23, 2000.

(51) Int. Cl. G06F 9/45

(52) U.S. Cl. 703/22

(57) ABSTRACT

A computer program product is disclosed that causes the computer to perform the following: a configuration of a structured system for the planning, integration, analysis and management of new product development on a real-time, enterprise-wide basis at the initiation of the computer code, the system comprising: a portfolio planning and management component; a project planning and management component; a resource planning and management component; and a process planning and management component; a modification of one of the components by an operator command; and an automatic reconfiguration of each of the other components to conform with the modified one of the components. A method is disclosed for assigning resource capacity to projects, the method comprising: directing a list of requests for resources issued by a project team to at least one appropriate resource group manager based upon resource configuration; analysis of the list of requests by the at least one resource group manager to make a determination as to the capacity for assigning the requested resources to the project; and assigning capacity to the project based on the determination made by the at least one resource manager.

### BACKGROUND OF THE INVENTION

Many complex systems exist in the real world. For example, there are complex natural systems (e.g., physical and biological systems) and complex man-made systems (e.g., social and industrial systems).

It has generally been found that such complex systems can be better understood and, in some cases, better managed, by using a so-called structured approach or methodology.

The present invention is directed to one such complex system, i.e., new product development (also sometimes referred to as “Development Chain Management”), and to a structured system for the planning, integration, analysis and management of the same.

Currently, relatively few tools exist for conducting a structured integration of new product development processes. In addition, the few tools which do exist are generally limited to (1) “stand-alone” tools which are designed solely for the analysis of a single new product development project, and (2) “stand-alone” tools which are designed solely for the analysis of a strategic portfolio, and (3) “stand-alone” tools which are designed solely for the analysis of resources, but none of them are designed for integrating all of the foregoing.

Unfortunately, however, many large enterprises must simultaneously plan and execute numerous new product development projects. These planned and in-progress projects must compete with one another for the limited resources available to the enterprise, e.g., people, facilities, machines, etc. As enterprises have become more and more sophisticated, they have begun to look at how they can coordinate their numerous new product development projects so as to balance new product yield, resource consumption, and business strategy. This typically means that enterprises wish to evaluate their numerous new product development projects on an enterprise-wide basis, rather than on just a single project basis, so as to ensure optimal planning, integration, analysis and management.

Unfortunately, attempts to utilize existing, “stand-alone” new product development tools on a large-scale, enterprise-wide basis have proven unsatisfactory. More particularly, using “stand-alone” tools to simultaneously evaluate multiple new product development projects across an entire enterprise tends to overwhelm the tools, leading to inconsistent standards and information reporting, and making it impossible to provide adequate information or a real-time basis. Thus, attempts to utilize existing “stand-alone” tools on an enterprise-wide basis typically results in questionable data delivered on an untimely basis.

### OBJECTS OF THE INVENTION

Accordingly, a primary object of the present invention is to provide a novel structured system for the planning, integration, analysis and management of new product development on a real-time, enterprise-wide basis.

Another object of the present invention is to provide a novel structured system for the planning, integration, analysis and management of new product development on a real-time, enterprise-wide basis which can simultaneously accommodate the needs of enterprise management (erg., executive review committees or portfolio managers, etc.), project managers and resource managers.

### SUMMARY OF THE INVENTION

These and other objects are addressed by the present invention, which comprises a novel structured system for the planning, integration, analysis and management of new product development on a real-time, enterprise-wide basis.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like elements and further wherein:

FIG. 1 is a schematic diagram illustrating the general architecture of the novel system of the present invention;

FIG. 2 is a schematic diagram illustrating the general relationship between an enterprise and its portfolios and projects and resources;

FIG. 3 is a schematic diagram illustrating various aspects of a project;

FIG. 4 is a schematic diagram illustrating various aspects of resources;

FIG. 5 is a schematic diagram illustrating various aspects of resource groups;

FIG. 6 is a schematic diagram illustrating various aspects of skill families;

FIG. 7 is a flowchart illustrating a preferred methodology for the system's process planning and management component;

FIG. 8 is a schematic diagram illustrating a common relationship between planning and resources;

FIG. 9 is a schematic diagram illustrating resource configuration and assignment;

FIG. 9A is a schematic diagram illustrating the assignment of resource capacity to projects;

FIG. 10 is a schematic diagram illustrating a process hierarchy;

FIG. 11 is a schematic diagram illustrating aspects of the reconciliation engine's scheduling feature;

FIG. 12 is a schematic diagram and two associated charts illustrating aspects of the reconciliation engine's resource feature; and

FIG. 13 illustrates a general methodology for calculating capacity in various situations in the system.

### DETAILED DESCRIPTION OF THE INVENTION

### System Overview

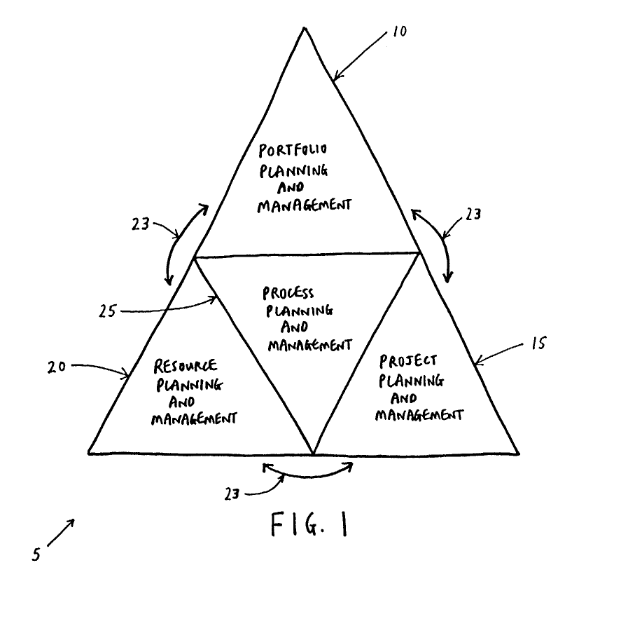

Looking first at FIG. 1, there is shown a diagram which schematically illustrates the general architecture of the novel structured system of the present invention. More particularly, the present invention comprises a novel structured system 5 for the planning, integration, analysis and management of new product development on a real-time, enterprise-wide basis. System 5 is adapted to coordinate the relationship between three basic system components: (1) a portfolio planning and management component 10; (2) a project planning and management component 15; and (3) a resource planning and management component 20. These three basic system components, and the manner in which they interact with one another, provide the overall structured construct for the planning, integration, analysis and management of new product development on a real-time, enterprise-wide basis.

As shown by the three arrows 23 in FIG. 1, there is an interaction between project planning and management component 15 and portfolio planning and management component 10; and there is an interaction between resource planning and management component 20 and portfolio planning and management component 10; and there is an interaction between project planning and management component 15 and resource planning and management component 20. In other words, there is a dynamic relationship between the planning and management of a specific project and the planning and management of a portfolio to which that project belongs; and there is a dynamic relationship between the planning and management of resources and the planning and management of a portfolio to which those resources are associated; and there is a dynamic relationship between the planning and management of a project and the planning and management of the resources which are utilized by that project.

In accordance with the present invention, portfolio planning and management component 10, project planning and management component 15, and resource planning and management component 20 are coordinated with one another through a fourth basic system component, which is a process planning and management component 25.

Significantly, all four of the system's basic components (i.e., portfolio planning and management component 10, project planning and management component 15, resource planning and management component 20, and process planning and management component 25) are dynamic elements, in the sense that they are intended to be configured at the initiation of the system, but are capable of being, and in fact are intended to be, adjusted or modified during the life of the system, with the adjustments or modifications flowing appropriately through all of the elements of the single structured system.

In one preferred implementation of the present invention, system 5 is embodied in software developed by Integrated Development Enterprise, Inc. of Concord, Massachusetts under the name IDweb™. Further details regarding system 5 are disclosed below or are disclosed in the product brief for IDweb™ (entitled “IDweb DEVELOPMENT CHAIN MANAGEMENT SOLUTION”), a copy of which is attached as APPENDIX A, or are disclosed in the product brochure for IDweb™ (entitled “IDweb the profit integrated from the solution for e-management development of product chain development management”), a copy of which is attached as APPENDIX B, or are disclosed in a product presentation for IDweb™ (entitled “PRODUCT PRESENTATION FOR IDweb”), a copy of which is attached as APPENDIX C.

### Portfolio Planning and Management Component 10

Portfolio planning and management component 10 relates to the high level planning, integration, analysis and management of projects and resources on an enterprise-wide basis as viewed in the context of an articulated portfolio strategy. In other words, portfolio planning and management component 10 is the portion of the system that is used by enterprise management to plan, analyze and oversee the various projects and resources of the enterprise.

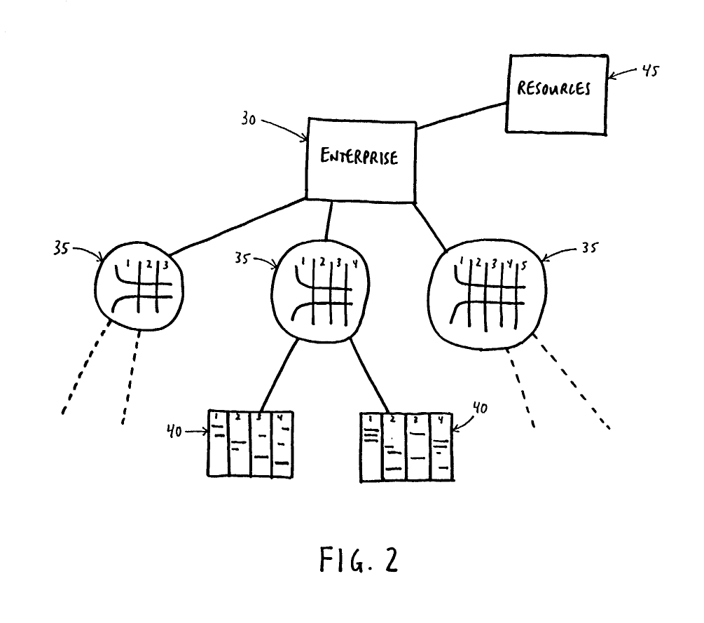

In accordance with the present invention, and looking now at FIG. 2, an enterprise 30 can be viewed, schematically, as consisting of one or more portfolios 35, wherein each portfolio 35 comprises one or more specific projects 40 which are to be planned, analyzed and reviewed on a common standard. Enterprise 30 typically has a limited supply of resources 45 with which to carry out its various projects 40.

In one preferred implementation of the present invention, portfolio planning and management component 10 is embodied in software developed by Integrated Development Enterprise, Inc. of Concord, Massachusetts under the name ID pipeline™. As will hereinafter be discussed in further detail, the IDpipeline™ software aggregates system data for management and presents that data to management in a visually compelling way. Depending on the type of data which is to be presented, the data could be presented in a pipeline diagram, a pie chart, a bar chart, etc.

Further details regarding portfolio planning and management component 10 are disclosed below or are disclosed in the user manual for IDpipeline™, a copy of which is attached as APPENDIX D.

### Project Planning and Management Component 15

Project planning and management component 15 relates to the planning and management of a single, specific new product development project as viewed in the context of a larger enterprise. In other words, project planning and management component 15 is the portion of the system which is used by specific project managers to plan, analyze, review and implement various aspects of their specific project.

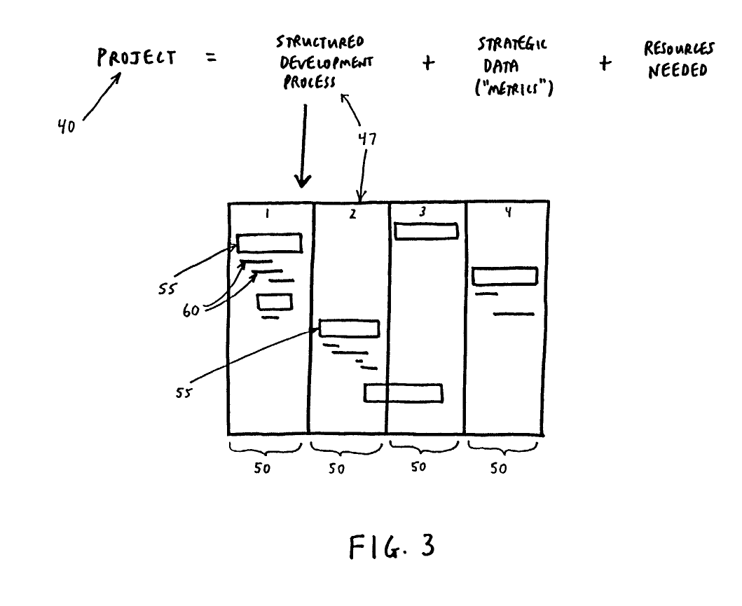

In accordance with the present invention, and looking now at FIG. 3, a specific project 40 can be viewed, schematically, as consisting of a structured development process 47 consisting of one or more phases 50, plus the strategic data (or “metrics”) associated with that project, plus the resources needed to implement that project.

The project's phases 50 may also include a plurality of subordinate steps 55, each of which may include one or more subordinate tasks 60, etc. Furthermore, the system is configured so that deliverables (e.g., documents, prototypes, etc.) and resources can be attached to elements of the structured development process (i.e., to projects, phases, steps, tasks, etc.).

Examples of the strategic data (“metrics”) associated with a given project might include items like risk assessment, return on investment, attractiveness assessment, predicted project revenue, predicted cost of executing a project, etc.; essentially, any information associated with assessing the desirability of the project to the enterprise.

In one preferred implementation of the present invention, project planning and management component 15 is embodied in software developed by Integrated Development Enterprise, Inc. of Concord, Mass. under the name IDprojectvie™. As will hereinafter be discussed in further detail, the IDprojectview™ software provides the project manager with an interface for entering the appropriate data for their particular project into the system. In addition, the IDprojectview™ software provides the project manager with an intelligent viewer for reviewing pertinent information regarding the project. More particularly, in IDprojectview™, the intelligent viewer is configured so as to act in two ways: (1) it brings to the attention of the project manager information which has been previously identified as being important to the project manager, and (2) it identifies deviations from the project plan. In addition, IDprojectview™ permits the project manager to conduct localized scenario evaluations (i.e., to conduct limited “what ifs”) in the context of the entire system, taking into account the existence of projects other than their own. For example, IDprojectview™ allows the project manager to determine the effect, with respect to other projects and available resources, of pushing out a phase boundary or other dates by a certain amount of time.

Further details regarding project planning and management component 15 are disclosed below or are disclosed in the user manual for IDprojectview™, a copy of which is attached as APPENDIX E.

### Resource Planning and Management Component 20

Resource planning and management component 20 relates to the coordination of resources within the enterprise and the utilization those resources by specific projects. In other words, resource planning and management component 20 is the portion of the system which is used by resource planners to plan and manage the utilization of resources across the enterprise.

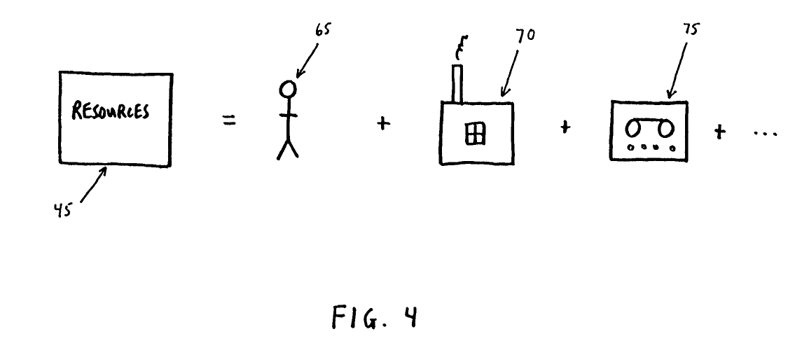

In accordance with the present invention, and looking now at FIG. 4, the enterprise's resources 45 can be considered to be made up of people 65, facilities 70, equipment 75, etc., all typically measured in terms of “FTE”, or “full time equivalents”.

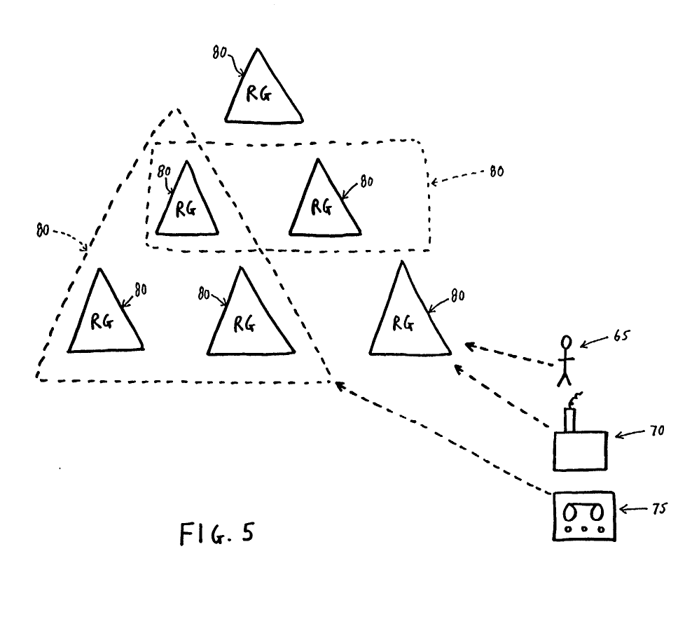

Also in accordance with the present invention, and looking now at FIG. 5, the enterprise can create various resource groups 80, which may in turn include other resource groups 80, whereby to effectively create a resource group hierarchy, for establishing how that enterprise organizes its resources. These resource groups can then be given “capacity” by associating specific resources with specific resource groups, as will hereinafter be discussed in further detail.

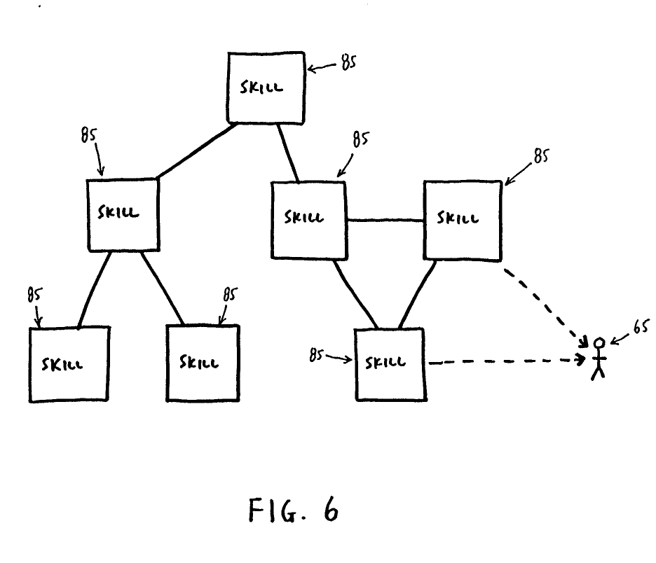

Also in accordance with the present invention, and looking now at FIG. 6, the enterprise can also create various skill categories 85, which may in turn be associated with other skill categories 85, so as to create a so-called skill family, for facilitating how the enterprise looks at the attributes of its resources. These skill families can then be associated with specific resources, as will also hereinafter be discussed in further detail below.

In one preferred implementation of the present invention, resource planning and management component 20 is embodied in software developed by Integrated Development Enterprise, Inc. of Concord, Mass. under the name IDresource™.

Further details regarding resource planning and management component 20 are disclosed below or in the user manual for IDresource™, a copy of which is attached as APPENDIX F.

### Process Planning and Management Component 25 “Process Mapper”

As noted above, portfolio planning and management component 10, project planning and management component 15 and resource planning and management component 20 are integrated and coordinated with one another in the present system through the use of process planning and management component 25. More particularly, process planning and management component 25 is the portion of the system which is used by process planners to coordinate the other portions of the system, i.e., portfolio planning and management component 10, project planning and management component 15 and resource planning and management component 20.

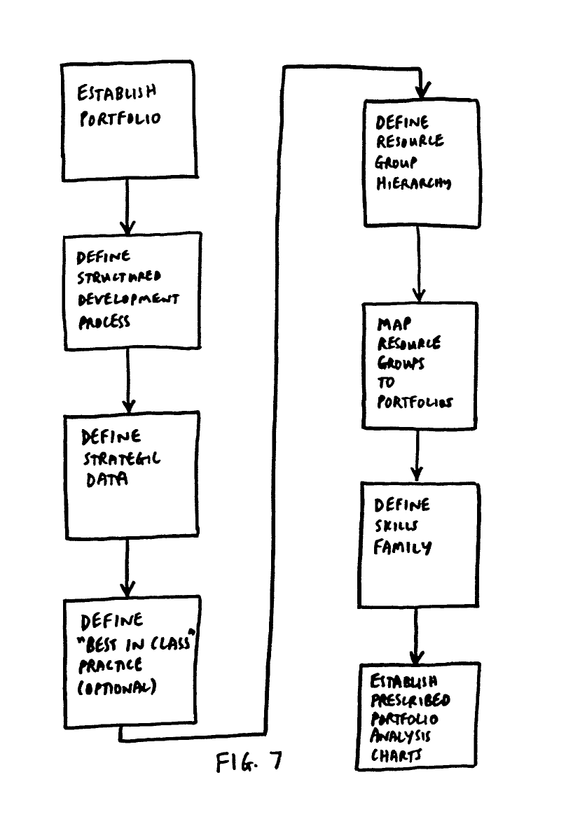

In accordance with the present invention, and looking now at the flowchart shown in FIG. 7, process planning and management component 25 preferably utilizes a specific methodology to establish the constructs which integrate and coordinate the interaction of the three other basic components of the system, i.e., portfolio planning and management component 10, project planning and management component 15 and resource planning and management component 20. More particularly, this preferred methodology is as follows:

(1) establish the portfolio (i.e., establish a definition for a group of projects which will be measured against a common set of standards and, therefor, dealt with on a portfolio-wide basis;

(2) define the structured development process 47 (FIG. 3) which is to be used for the various projects in that portfolio—in particular, this portion of the process consists of defining at least the phases required of all projects in that portfolio;

(3) defining the strategic data (i.e., the “metrics”) which is to be tracked for all of the projects in a given portfolio;

(4) optionally, defining a “best in class” practice, which acts as a sort of template for new projects, whereby to steer each new project toward the best practices previously identified by the organization—this process can involve defining specific subordinate steps and specific subordinate tasks which will be involved in projects in the portfolio or, alternatively, it can involve defining an entire project template (optionally including subordinate steps and subordinate tasks);

(5) defining the resource group hierarchy (which could be, if desired, flat);

(6) mapping the resource groups to the portfolios;

(7) defining the skills family and, optionally, to the extent that “best in class” practice was defined in Step 4, defining specific resources for use in the “best in class” practice; and

(8) establishing the prescribed portfolio analysis charts which will used by management to review the portfolio.

If desired, Step 8 can be conducted earlier, e.g., any time after Step 3. In fact, Steps 3 through 8 can vary in sequence, provided, however, that Step 5 must precede Step 6.

In one preferred implementation of the present invention, process planning and management component 25 is embodied in software developed by Integrated Development Enterprise, Inc. of Concord, Mass. under the name IDprocess™. IDprocess™ effectively walks the process planner through a process set-up (also known as the “Process Mapper”) so as to appropriately configure the system.

Further details regarding process planning and management component 25 are disclosed below or in the user manual for IDprocess™, a copy of which is attached as APPENDIX G.

### Resource Configuration and Assignment “Resource Evaluator”

As noted above, the process planning and management component 25 is used to define the resource group hierarchy, map the resource groups to the portfolios, and define the skills family. These steps, in combination with others, are commonly referred to as “resource configuration and assignment”.

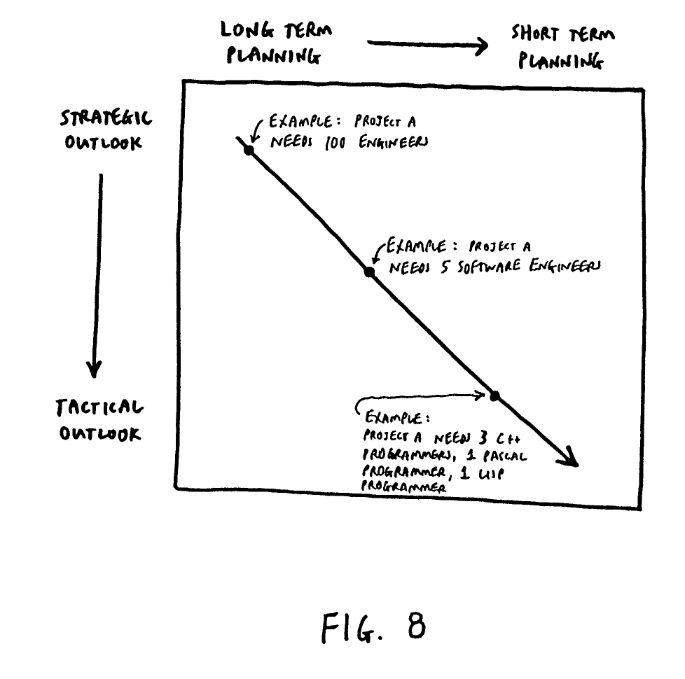

More particularly, and looking now at FIG. 8, there is schematically illustrated a common relationship between planning and resources. In essence, this diagram reflects the fact that planning typically begins on a long-term, strategic basis and evolves into a short term, tactical basis. During this evolution, resources are typically thought of in an increasingly specific manner.

By way of example but not limitation, during the strategic planning phase, a particular project might only anticipate that it needs a hundred engineers; at a later stage in the process, that same project might determine that it needs five engineers; and at a still later stage in the process, that same project might determine that it needs three C++ programmers, one Pascal programmer, and one LISP programmer.

By way of further example but not limitation, during the strategic planning phase, the enterprise might only anticipate that it needs five hundred engineers; at a later stage in the process, the enterprise might determine that a particular resource group needs ten software engineers; and at a still later stage in the process, the enterprise might determine that this same resource group needs six C++ programmers, one Pascal programmer, one Perl programmer and one LISP programmer.

In this respect it should also be appreciated that at the strategic level, it may be desired to reserve general capacity, without reference to a specific resource element (e.g., to reserve 100 engineers); however, at the tactical level, it may be desired to assign specific capacity in the form of a specific resource (e.g., to assign engineer Harry Smith). The system is configured so as to smoothly accommodate this transition from strategic planning to tactical implementation.

The present system is able to accommodate this evolutionary, increasingly-specific process of identifying resource needs, and assigning resource capacity, due to the unique way in which resource groups, skills and resources are configured in the present system.

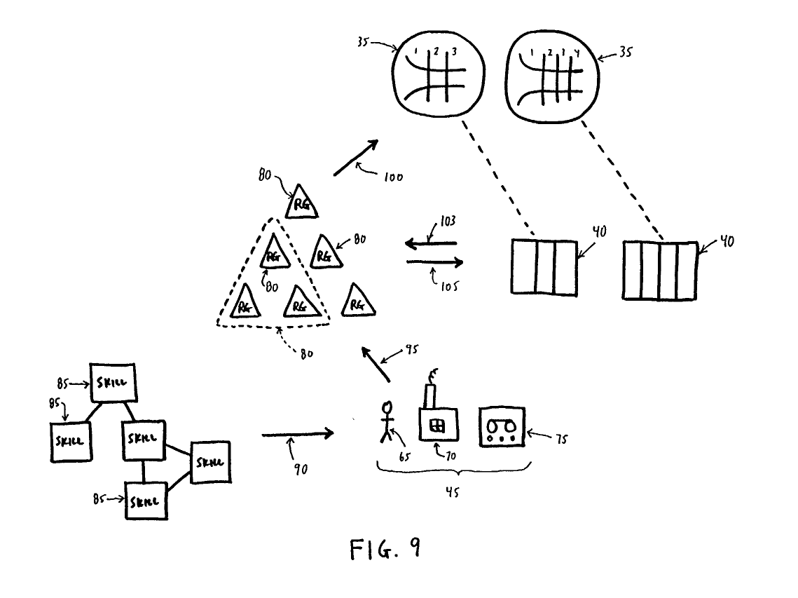

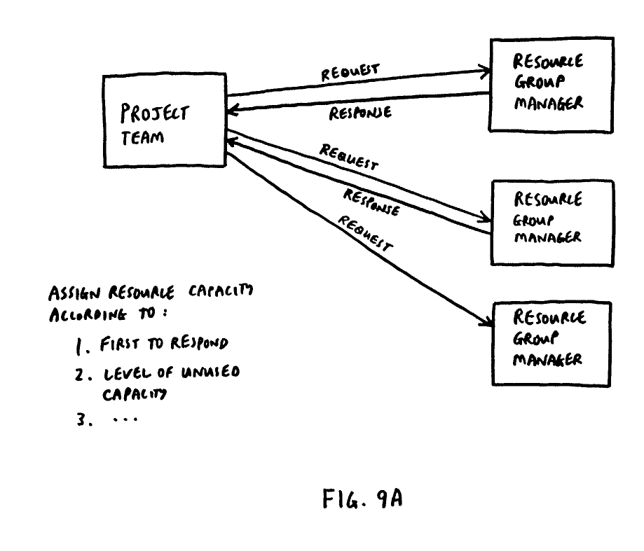

Looking next at FIG. 9, there is schematically illustrated a preferred method for resource configuration and assignment. This preferred method comprises the following steps:

1. the process planner configures the resource group hierarchy;

2. the process planner configures the skill family definitions;

3. the resource manager associates zero or more skills to a resource (see the arrow 90 in FIG. 9);

4. the resource manager associates each resource to a particular resource group (see the arrow 95 in FIG. 9)—this association is commonly to a lowest level resource group, but it could be to a higher level resource group if desired;

5. the process planner associates specific resource groups to specific portfolios, thereby establishing the “default” pool of resources which a specific project in a specific portfolio may draw on (see the arrow 100 in FIG. 9);

6. resource needs are issued as requests (see the arrow 103 in FIG. 9); and

7. resources are assigned to specific projects (see the arrow 105 in FIG. 9).

Items 1-5 above effectively amount to the configuration of the resources.

Items 6 and 7 above effectively amount to a resource assignment transaction.

With respect to Items 6 and 7 above, i.e., resource assignment, the system is configured to do this on two levels, dealing first with capacity and then with specific resources. For the purposes of the present invention, the term “capacity” is intended to mean the aggregation of resource capabilities, but not identified as to specific resource units. The assignment of resource capacity to specific projects is a dynamic process which (see FIG. 8) becomes progressively more specified over the life of the project. Furthermore, as the system becomes progressively more specified with respect to a given project, resource assignment can be done on the basis of the overall project or on a phase-specific basis or on a step-specific basis.

There are three techniques for assigning resource capacity to projects.

A first technique utilizes the following process:

1. the project team issues a list of “needs” as requests which are directed to appropriate resource groups based upon resource configuration;

2. one or more resource group managers analyze the request and make determinations as to resource assignment; and

3. the project receives the capacity decided on by the resource manager.

A second technique for assigning resource capacity to projects utilizes the following process:

1. the project team issues a list of “needs” as requests which are directed to appropriate resource groups based upon resource configuration;

2. one or more resource group managers analyze the request and make a determination as to resource capacity assignment;

3. the determination of the resource group manager is passed on to the portfolio manager, who then approves, disapproves or modifies the determination, and then sends it back to the resource manager; and

4. the project receives capacity decided on by the portfolio manager.

A third technique for assigning resource capacity with projects utilizes the following process:

1. the project manager issues a list of “needs” as requests which are directed to appropriate resource groups based upon resource configuration;

2. one or more resource group managers analyze the request and make a determination as to resource capacity assignment;

3. the project receives a tentative capacity assignment based on the determination made by the resource manager; and

4. the portfolio manager approves the determination made by the resource manager, and the assignments are confirmed.

With respect to the aforementioned three different techniques for assigning resource capacity to projects, it will be appreciated that they all share a common second step, i.e., “one or more resource group managers analyze the request and make a determination as to resource capacity assignment”. In this respect, it should be appreciated that the system is configured so that it can utilize various methods for implementing this procedure when more than one resource group manager responds to a request. For example, in one simple method, resource capacity is assigned according to which resource group manager responds first. Alternatively, where several resource group managers respond to a request, resource capacity can be assigned on a pro rata basis, according to the unused resource capacity of each responding resource group. See, for example, FIG. 9A.

Two significant advantages are achieved by using the aforementioned system of resource configuration and assignment.

First, by creating a general structure of resource configuration and then associating resource capacity into that general structure, it is possible to extract out resource capacity information at any level of aggregation within the system. In other words, it is possible to look at any level of portfolio or project, or any level of skill, or any particular resource, to determine resource utilization (including bottlenecks) within the system.

Second, by creating the general structure of resource configuration and assignment across the enterprise, it is possible to identify how projects and resources affect one another. This allows managers to see the influence of projects and resource groups on each other, both when the projects and resources are closely associated within the enterprise, and when the projects and resources are loosely associated within the enterprise.

### Process Hierarchy

As noted above, one consequence of the system's architecture is that all of the projects 40 in a given portfolio 35 must conform to the criteria specified for that portfolio by the process planning and management component 25, i.e., all of the projects 40 must track against, and report on the basis of, (1) the same structured development process 47 (e.g., phases 50), (2) the same strategic data, and (3) the same skills. In essence, with the unique architecture of the present system, the structured development process, strategic data and skills defined for a given portfolio during the process planning stage is automatically imposed upon all of the projects grouped within that portfolio.

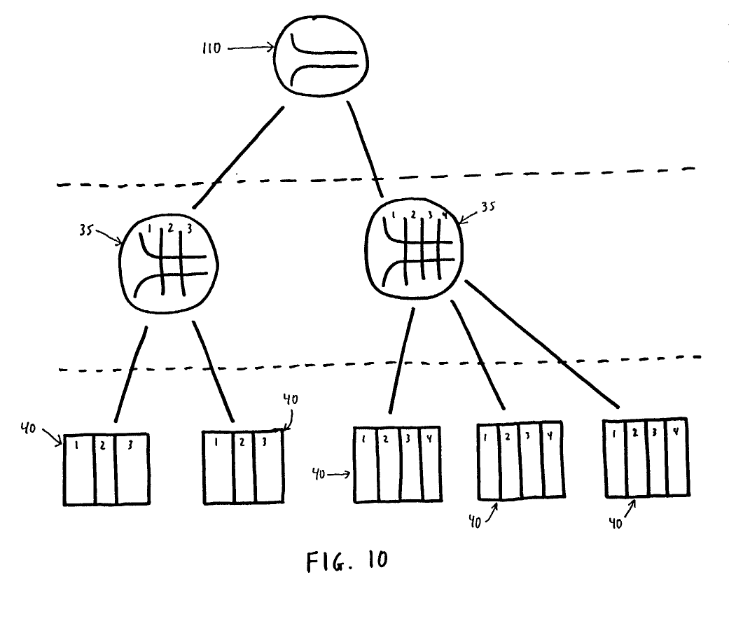

This concept is illustrated schematically in FIG. 10, where a number of different portfolios 35 are shown, each with a number of projects 40 assigned thereto. This relationship can be thought of as a process hierarchy, with each of the projects 40 residing “below” a “parent” portfolio 35 and inheriting from that parent portfolio the specific criteria which is to be tracked for each project (i.e., the structured development process, strategic data and skills).

In accordance with a further significant feature of the present invention, it has also been recognized that portfolios can have their own hierarchy, i.e., two or more portfolios 35 can themselves be associated with another portfolio, e.g., a “superportfolio” 110, wherein the portfolios 35 inherit their tracking criteria from the superportfolio 110 and then, in turn, impose that inherited criteria on all of the projects 40 below them.

In other words, as shown in FIG. 10, a consequence of the system's architecture is that there is a hierarchy, or system of inheritance, from superportfolio to portfolio to projects, etc., with each constituent in the system following the criteria imposed on it by the constituent immediately above it.

### Reconciliation Engine—Scheduling

As noted above, all of the projects within a given portfolio are required to conform to the same objective standards. Among these shared standards are the structured development process 47 (i.e., the relationship between phases, etc.) which is common to all of the projects in the portfolio.

The use of a common standard among all of the projects in the portfolio is a powerful tool, since it allows data to be accurately and reliably aggregated upward from the project level to the portfolio level.

Furthermore, due to the nature of how the system organizes its data, this aggregation can be done with a “continuous zoom”, in the sense that the level of data granularity can be adjusted in a relatively continuous fashion.

And by implementing the preferred form of the invention in software, this aggregation can be accomplished in real-time, on an enterprise-wide basis, thereby providing the enterprise management with a truly powerful and uniquely integrated planning, integration, analysis and management tool.

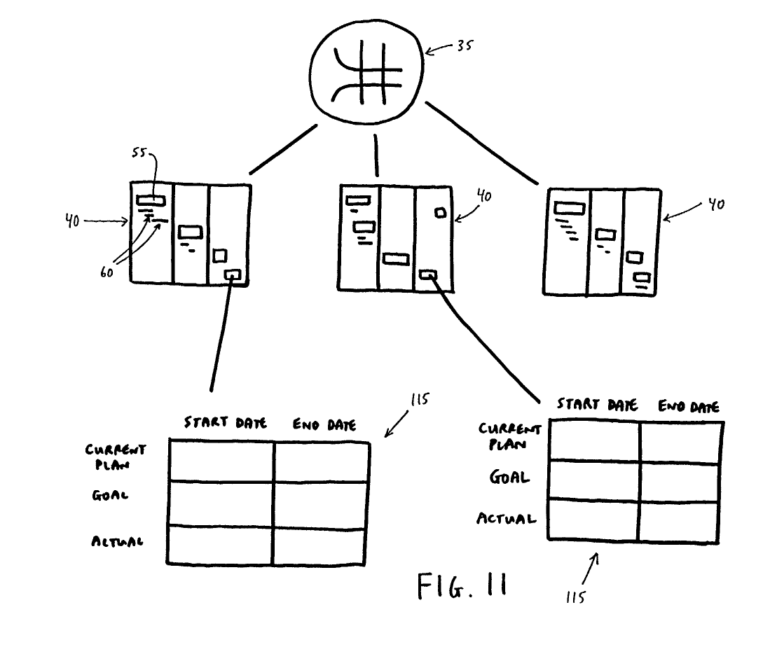

More particularly, and looking now at FIG. 11, there is shown, in schematic form, a portfolio 35 which has three projects 40 assigned thereto. The system is configured so that for each item in the structured development process 47, six pieces of data are tracked, i.e.:

1. Current Plan—Start Date

2. Current Plan—End Date

3. Goal—Start Date

4. Goal—End Date

5. Actual—Start Date

6. Actual—End Date

In one preferred form of the invention, these six pieces of data are stored in an appropriate data table 115 (FIG. 11).

Current plan information, and actual information, is adjusted on a continuous basis. Goal information is typically adjusted on a periodic basis, e.g., at the end of each phase.

By tracking these six criteria for each item in the structured development process, important benefits can be obtained. More particularly, by tracking these six criteria, the system can notify managers of “slips” in the system, i.e., where current plan, goal and actual dates vary from one another.

Of course, if the system notified every manager of every “slip” in the system, managers would be overwhelmed by the shear volume of information. Therefore, it is important that the system be able to discriminate as to which managers are to be notified as to which “slips”. With the present invention, this is made possible due to the way in which the system organizes its information. In particular, due to the system's reconciliation engine, it is possible to establish a “sliding scale” of alerts which discriminates between which managers are alerted to which “slips”.

With the present invention, system alerts can be generated on the basis of two different criteria: either implicitly or explicitly. An implicit alert is generated according to a set of pre-established rules which take into account the level of the manager and the type of slip involved. An explicit alert is generated according to a manager's specific request to be alerted to a specific slip.

More particularly, an implicit alert is generated according to pre-established rules, i.e., the system can be configured so that a portfolio manager is alerted when a project phase is missed but not when a task is missed, whereas a project manager is alerted when a task is missed, as well as when a project phase is missed, etc.

In this respect it should also be appreciated that the system can be configured so that a “slip” is defined in relative terms, i.e., the system can be configured to permit a level of tolerance to be assigned to a date. In other words, the system can be configured to give a “grace period” around a deadline.

Furthermore, the system is also configured so that alerts can be proactive as well as reactive. In other words, by looking at “current plan” dates versus “goal” dates, the system can provide alerts as to anticipated slips.

As noted above, an explicit alert is generated according to a specific request by a manager, e.g., manager X has a significant interest in a specific high level task, and instructs the system to issue an alert with respect to any slips affecting that task.

### Reconciliation Engine—Resources

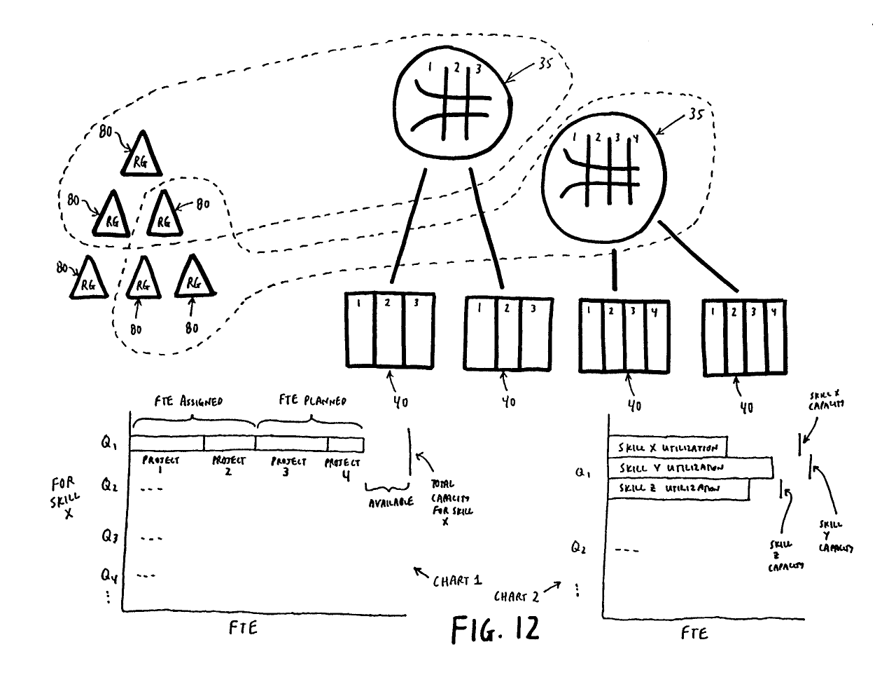

As noted above, and looking now at FIG. 12, all of the projects 40 belong to some portfolio 35, with clearly defined constructs relating the projects to the portfolios. At the same time, specific resource groups 80 are associated with specific portfolios 35, with specific resources assigned to specific projects. Thus, there is a unifying construct between portfolios, projects, resource groups and resources. The use of this unifying construct is a powerful tool, since it allows resource data to be accurately and reliably aggregated both vertically and horizontally within the system. Furthermore, due to the nature of how the system organizes its data, this aggregation can be done with a “continuous zoom”, in the sense that the level of data granulation can be adjusted in a relatively continuous fashion. In addition, this aggregation can be based on existing and/or proposed projects, and existing and/or proposed resource capacity, thereby permitting the user to conduct “what if” analyses. And by implementing the preferred form of the invention in software, this aggregation can be done in real-time, on an enterprise-wide basis. Central to one aspect of this invention's novelty lies the fact that it is not resource capacity in a vacuum—the capacity the system calculates from is added to, and reduced from, in a dynamic, real-time seamless manner. The capacity of resources is integrated with the needs of projects which are integrated with the portfolio strategy.

Thus, for example, and looking now at Chart 1 in FIG. 12, with the present invention it is possible to generate a chart, for any given skill, which will show, for a particular time period, the total FTE assigned and/or planned, broken out on a project by project basis. This can be an important measure, since it can be compared with the total capacity for that particular skill, whereby to identify imbalances between the supply and demand of the specified skill. The ability to access capacity utilization trends over time is an important feature of not only this chart in particular but also the system in general, for once those trends are determined, portfolio managers can then align the currently-utilized and planned capacity with the dynamic strategy of the portfolio.

Additionally, and looking now at Chart 2 in FIG. 1, it is also possible to use the information available in the system to generate a chart showing, for any particular time period, the difference between the capacity for each skill and the level of utilization for that same skill.

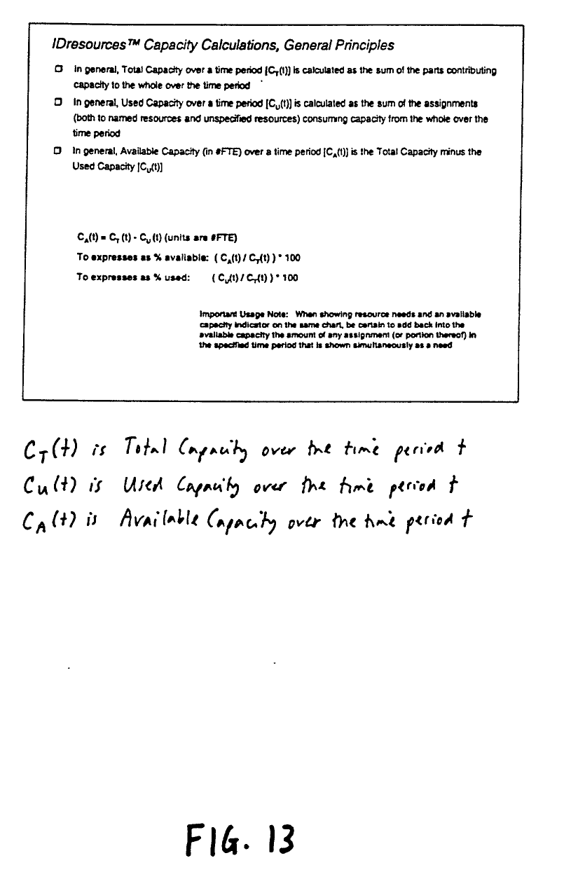

Looking next at FIG. 13, there is shown a general methodology for calculating capacity in various situations in the system.

### Addendum

Still other objects and features of the present invention are disclosed in a first collection of pages entitled “Integrated Development Enterprise, Inc. IDresources™”, a copy of which is attached as APPENDIX H, and a second collection of pages marked “ADDITIONAL SHEETS”, a copy of which is attached as APPENDIX I.

What is claimed is:

1. A computer program product embodied on a computer-readable medium and comprising code that, when executed, causes the computer to perform the following:
a configuration of a structured system for the planning, integration, analysis and management of new product development on a real-time, enterprise-wide basis at the initiation of said computer code, said system comprising:
a portfolio planning and management component;
a project planning and management component;
a resource planning and management component; and
a process planning and management component;
a modification of one of said components by an operator command; and
an automatic reconfiguration of each of said other components to conform with said modified one of said components.

2. A method for assigning resource capacity to projects, said method comprising:
directing a list of requests for resources issued by a project team to at least one appropriate resource group manager based upon resource configuration;
analysis of said list of requests by said at least one resource group manager to make a determination as to the capacity for assigning the requested resources to said project; and
assigning capacity to said project based on said determination made by said at least one resource manager.

3. A method for assigning resource capacity to projects, said method comprising:
directing a list of requests for resources issued by a project team to at least one appropriate resource group manager based upon resource configuration;
analysis of said list of requests by said at least one resource group manager to make a determination as to the capacity for assigning the requested resources to said project;
directing said determination made by said at least one resource group manager to a portfolio manager for approval, disapproval or modification; and
assigning capacity to said project based on said approval, disapproval or modification made by said portfolio manager.

4. A method for assigning resource capacity to projects, said method comprising:
directing a list of requests for resources issued by a project team to at least one appropriate resource group manager based upon resource configuration;
analysis of said list of requests by said at least one resource group manager to make a determination as to the capacity for assigning the requested resources to said project;
transmitting a tentatively assigned capacity to said project team based on said determination made by said at least one resource manager; and
confirming said tentatively assigned capacity after a portfolio manager approves said determination made by said at least one resource manager.

5. A computer program product embodied on a computer-readable medium and comprising code that, when executed, causes the computer to perform the following:
a determination of resource capacity for each resource group;
a determination of resource assignment for each project;
an analysis of said determined resource group capacity and said determined project assignment with one another; and
a generation of a report illustrating the same.

6. A computer program product embodied on a computer-readable medium and comprising code that, when executed, causes the computer to perform the following:
a review of data items contained in a schedule for enterprise management, said data items including current plan information, goal information and actual information;
continuous adjustments of said current plan information and said actual information on a continuous basis, and adjustments of said goal information on a given periodic basis;
a comparison of said current plan information, said actual information, and said goal information to one another as determined by said continuous adjustments and said periodic adjustments; and
a notification of a variance of said current plan information, said actual information, and said goal information to one another as determined by said comparison.

7. A computer program product embodied on a computer-readable medium and comprising code that, when executed, causes the computer to perform the following:
an association of at least two portfolios with one another to create a superportfolio inheriting tracking criteria from each of said at least two portfolios;
an imposition of said inherited tracking criteria from said superportfolio on said association of said at least two portfolios creating said superportfolio; and
an imposition of said inherited tracking on projects subordinate to each of said at least two portfolios of said association.
